(19) United States
(12) Patent Application Publication
(10) Pub. No.: US 2024/0160807 A1
(43) Pub. Date: May 16, 2024

(54) METHOD FOR SIMULATING A TECHNICAL DEVICE

(71) Applicant: Robert Bosch GmbH, Stuttgart (DE)

(72) Inventors: Oliver Kotte, Lampertheim (DE); Laura Beermann, Waldbronn (DE); Srivathsan Ravi, Bangalore (IN)

(21) Appl. No.: 18/506,349

(22) Filed: Nov. 10, 2023

(30) Foreign Application Priority Data
Nov. 16, 2022 (DE) 10 2022 212 177.5

(51) Int. Cl. G06F 30/20

(52) U.S. Cl. CPC G06F 30/20; G06F 2119/12

(57) ABSTRACT

A computer-implemented method for simulating a technical device, wherein a plurality of hardware units are connected to one another via a network in the technical device to be simulated. The method includes simulation of the individual hardware units by a hardware simulation unit, in particular by executing software to be executed in the individual hardware units; simulation of the network by a network simulation unit, in particular by simulating data transmissions between the individual hardware units via the network; determination of a simulation time base by a time simulation unit; and temporal coordination of the simulation of the individual hardware units and of the simulation of the network by the time simulation unit based on the simulation time base.

### CROSS REFERENCE

The present application claims the benefit under 35 U.S.C. § 119 of German Patent Application No. DE 10 2022 212 177.5 filed on Nov. 16, 2022, which is expressly incorporated herein by reference in its entirety.

### FIELD

The present invention relates to a computer-implemented method for simulating a technical device, and to a computing unit or a system of computing units, and to a computer program for carrying out the same.

### BACKGROUND INFORMATION

Technical devices having a plurality of hardware units, for example a (motor) vehicle having a plurality of control units, can be modeled or simulated in computing units, such as PCs, for example by the individual hardware units or their functions being simulated in the computing unit by specific simulation software, for example as a virtual machine. For example, software which is executed by the individual hardware units in their regular operation can be executed in the course of the simulation in the computing unit or in the virtual machine.

### SUMMARY

According to the present invention, a computer-implemented method for simulating a technical device, and a computing unit or a system of computing units, and a computer program for carrying out same, are provided. Advantageous embodiments of the present invention are disclosed herein.

In the technical device to be simulated, a plurality of hardware units are connected to one another via a network or a communication system and are thus in communication connection with one another. In this context, a technical device is in particular understood to mean a unit or a system of various units for executing a technical process, in particular a regulation and/or control process. The technical device to be simulated may, for example, be a machine, i.e., a device for energy or force conversion, or an installation or a system made up of a plurality of components, e.g., of a plurality of machines. In particular, the technical device to be simulated is a (motor) vehicle. For example, the individual hardware units can in each case be control units or control devices which control or regulate individual components or processes of the technical device. The network may, for example, be an industrial communication system, in particular a fieldbus system, such as CAN, Ethernet/IP, ProfiNet, Sercos 2, Sercos III, EtherCAT, FlexRay, LIN, MOST, etc.

Within the scope of the method according to the present invention, the individual hardware units are simulated by a hardware simulation unit, in particular by executing software to be executed in the individual hardware units. A functional simulation is thus carried out, in the course of which the operation, function and functionality of the individual hardware units are digitally simulated in the hardware simulation unit. These simulated hardware units can expediently be corresponding virtual machines, e.g., virtual control units.

Furthermore, according to an example embodiment of the present invention, the network is simulated by a network simulation unit, in particular by simulating data transmissions or message transmission between the individual hardware units via the network. A network simulation, in the course of which communication or a data exchange between the hardware units during operation of the technical device is simulated, is thus carried out in the network simulation unit.

Furthermore, within the scope of the method according to an example embodiment of the present invention, a simulation time base or a simulated time base is determined by a time simulation unit. The time simulation unit temporally coordinates the simulation of the individual hardware units and the simulation of the network with one another based on the determined simulation time base. The simulated hardware units and the simulated network are thus temporally coordinated with one another. The time simulation unit thus in particular executes a time simulation and, in the course thereof, provides a common, central, superordinate time notation or a corresponding superordinate time frame for the simulations of the hardware units and of the network. The time simulation unit expediently coordinates the sequences of the functional simulation and of the network simulation and, in particular, specifies when individual actions or events of these simulations are to be executed or processed dependently on one another.

The hardware simulation unit, the network simulation unit, and the time simulation unit can respectively be provided as a software unit or a software module, for example, and can in particular be part of superordinate simulation software. The hardware-, network- and time simulation units or this simulation software can, for example, be executed jointly in a computing unit. However, it is also possible that individual or all hardware-, network- and time simulation units are respectively executed on a separate computing unit.

Within the scope of the present description, a distinction is in particular made between the terms “hardware unit to be simulated” and “simulated hardware unit” and between the terms “network to be simulated” and “simulated network” and between the terms “technical device to be simulated” and “simulated technical device.” For example, the term “hardware unit to be simulated” is in particular understood to mean the actual physical unit that is to be digitally simulated, i.e., for example, a control unit having a microprocessor/microcontroller. The term “simulated hardware unit” accordingly is understood to mean the digitally simulated hardware unit which thus exists only in software and not as an actual physical unit. Corresponding explanations apply to the network to be simulated or simulated network and to the technical device to be simulated or simulated technical device.

The present invention provides a possibility to carry out the simulation of the technical device as close to reality as possible even with regard to the temporal sequence and to be able to simulate the execution of the software by the hardware unit and the communication of the hardware units with one another as close to reality as possible in the simulation. The individual processes of the software and of the individual data transmissions are particularly expediently executed in the course of the simulation with the same or at least substantially with the same latencies or processing times as in the actual technical device. The execution of the software and the communication between the hardware units in the course of the simulation expediently take place in a temporally coordinated manner with the actual technical device to be simulated.

In actual hardware units, a particular amount of time that depends on the hardware used is required for the execution of software or code. In conventional simulations, e.g., in conventional software-in-the-loop (SiL) simulation, such hardware-dependent execution times are often not taken into account. Hardware units simulated in a conventional manner are therefore often temporally inaccurate. Such temporally inaccurate, simulated hardware units are often also used if a plurality of hardware units and virtual networks are simulated together with physics-based device models. In this case, temporal aspects of the network, such as latencies or other delays in data transmissions, are often not taken into account, which can lead to great inaccuracies of such simulations. In contrast, according to the present invention, temporal delays both in the execution of software and during the interaction via a network, for example due to hardware-dependent execution times or latencies, can be taken into account in the simulation of the technical device. Actual time sequences can thus be digitally simulated as precisely as possible.

For example, the present invention makes it possible to simulate a plurality of virtual engine control units (vECU) together in a physical device or system model in order to understand the interaction of the control software with the device model. The time simulation unit provides an integration tool in order to combine physically based device models with the correct behavior of E/E networks in the simulation and in order to thus jointly simulate, for example, a plurality of virtual engine control units with virtual networks.

According to one embodiment of the present invention, the simulation time base is determined depending on a process flow plan, according to which processes of the respective software are respectively processed in the individual hardware units, and/or depending on a data transmission plan, according to which data transmissions are carried out in the network. The process flow plan characterizes, in particular, how processes are respectively processed in the actual hardware units, e.g., when individual processes are started and how long their processing respectively lasts or may last at most. The process flow plan can, for example, also comprise or take into account an interaction, necessary for the execution of the individual processes, with the network. For example, the process flow plan can comprise that a result of an executed process is to be transmitted from the respective hardware unit via the network to a further hardware unit. Furthermore, the process flow plan can comprise, for example, that a respective hardware unit is to first receive data from a further hardware unit via the network, and that the respective process is to then be executed depending on these received data. The data transmission plan characterizes, in particular, the processing of data transmissions via the actual network and can, for example, describe in which order or according to which criteria data transmissions are carried out and how long individual data transmissions last or may last at most. For example, the data transmission plan can take into account priorities of individual messages or a required real-time behavior of the network.

According to one embodiment of the present invention, the simulation of the individual hardware units comprises determining the process flow plan for each of the hardware units and executing the software to be executed in the individual hardware units, according to the determined process flow plan. For example, the process flow plan can be determined by the hardware simulation unit in the course of the simulation of the hardware units or be stored in said hardware simulation unit and can then be read by the time simulation unit. For example, a common process flow plan can be specified for all hardware units, or a separate individual process flow plan can respectively also be specified for each simulated hardware unit.

According to one embodiment of the present invention, the simulation of the network comprises determining the data transmission plan and simulating data transmissions between the individual hardware units via the network according to the determined data transmission plan. The data transmission plan can, for example, be determined by the network simulation unit or be stored therein and be read by the time simulation unit.

According to one embodiment of the present invention, the simulation time base is determined depending on an execution duration and/or on an execution sequence of individual processes of the software to be executed in the individual hardware units. For example, this execution duration can take into account the hardware-dependent time required in the actual hardware unit to be simulated, for the execution of the respective process. Furthermore, the execution duration can, for example, also take into account a maximum permitted execution duration for individual processes, wherein a respective process is terminated, for example, if it has not been completely processed after this maximum duration. The execution sequence can in particular take into account priorities of individual processes. For example, the execution duration and the execution sequence can respectively be specified in the process flow plan.

According to one embodiment of the present invention, the simulation time base is determined depending on a transmission duration and/or on a transmission sequence of individual data transmissions between individual hardware units via the network. The transmission duration and the transmission sequence can, for example, take into account real-time conditions of the network.

Furthermore, the transmission duration can, for example, also take into account a maximum permitted transmission duration, wherein individual data transmissions are, for example, interrupted and discarded if they have not been completely transmitted within this maximum duration. The transmission duration and the transmission sequence can, for example, be specified in the data transmission plan.

According to one embodiment of the present invention, the simulation time base is determined depending on a delay time or latency of the execution of individual processes of the software to be executed in the individual hardware units, and/or on a delay time or latency of individual data transmissions between individual hardware units via the network. For example, technology-related delays in the simulation can thus also be taken into account. Expediently, these delay times can respectively be specified in the process flow plan or in the data transmission plan.

According to one embodiment of the present invention, the temporal coordination comprises temporally coordinating individual actions or events or simulation events with respect to an execution of individual processes of the software to be executed in the individual hardware units, and with respect to a transmission of individual data messages between the individual hardware units via the network. Such actions can, for example, relate to the start or the end of the processing of individual processes and the start or the end of the transmission of individual data messages. It is in particular taken into account how or when corresponding actions take place relative to one another in the actual technical device. For example, the time simulation unit can instruct the hardware and network simulation units to carry out particular actions relative to one another at particular points in time in order to simulate the actual time behavior of the technical device.

According to one embodiment of the present invention, the temporal coordination comprises sending time information from the time simulation unit to the hardware simulation unit and to the network simulation unit as well as respectively sending functionality information from the hardware simulation unit and from the network simulation unit to the time simulation unit. By means of this time information, the time simulation unit can in particular synchronize the hardware and network simulation units with one another and temporally coordinate them with one another. For example, instructions to carry out specific actions or to start the execution of specific actions can be sent as time information of this type. The hardware simulation unit and the network simulation unit can inform the time simulation unit by means of the functionality information, for example about the currently simulated functions or functionalities. For example, this functionality information can comprise information about actions or events carried out, e.g., information about individual processes having been completely processed. If, for example, processes are processed more quickly in the respective simulated hardware unit than in the actual hardware unit, the time simulation unit can, for example, use the time information to instruct the respective hardware units to wait to provide the respective process results until this would be the case in the actual hardware unit relative to other events.

According to one embodiment of the present invention, the temporal coordination comprises temporally coordinating one or more of the following actions: reading-in of data by the individual hardware units, e.g., in order to carry out a process depending on these read-in data; writing of data by the individual hardware units, e.g., as a result of a process carried out; starting of an execution of individual processes of the software to be executed in the individual hardware units; ending of an execution of individual processes of the software to be executed in the individual hardware units; obtaining of process results of individual processes of the software to be executed in the individual hardware units; outputting or forwarding of process results of individual processes of the software to be executed in the individual hardware units; interacting of individual hardware units with the network; sending of individual data messages of individual hardware units via the network; receiving of individual data messages of individual hardware units via the network. By coordinating these actions, or the points in time at which these actions take place, relative to one another, the actual time behavior of the technical device can be simulated particularly precisely and effectively in the simulation. Expediently, these actions are coordinated by means of the time and functionality information and also, in particular, with the aid of the particular execution duration, execution sequence, transmission duration, transmission sequence, and delay time or latency.

According to one embodiment of the present invention, the time simulation unit is provided as a unit that is superordinate to the hardware simulation unit and the network simulation unit. For example, the time simulation unit can function as a central, superordinate clock. In this way, use of different time sources or clocks for virtual hardware units and virtual networks can in particular be omitted, which can in particular lead to elimination of time synchronization problems. The time-, hardware- and network simulation units can, for example, be provided as a monolithic simulation with the time simulation unit as a central clock, which can be based on a common software application. It is also possible that individual or all of the time-, hardware- and network simulation units are respectively realized as standalone, independent software units, and that the time simulation unit, as the superordinate clock, synchronizes the individual software units with one another.

According to one embodiment of the present invention, the time simulation unit is respectively connected to the hardware simulation unit and to the network simulation unit via an interface, in particular in each case via an interface according to the Functional Mock-up Interface. The Functional Mock-up Interface (FMI) defines a standardized interface for coupling different simulation software. Different models or modules can be coupled by FMI and assembled into an overall model or an overall simulation. Such FMI interfaces are particularly suitable for coupling the time-, hardware-, and network simulation units. For example, individual simulation units can respectively be created or programmed individually and flexibly in different ways, without explicitly considering compatibility with the other units. Coupling and compatibility of the individual simulation units can expediently be generated by means of the FMI interfaces.

According to an example embodiment of the present invention, the time simulation unit and/or the hardware simulation unit and/or the network simulation unit are respectively designed as a software module according to a Functional Mock-up Unit (FMU). Such FMU modules are to be understood in particular as individual software containers which can be coupled with one another within the framework of the Functional Mock-up Interface to form an overall model. Such a FMU module comprises in particular a file, in particular an XML file, for defining variables, and also formulas which are used in the FMU module or the simulation, in particular defined as C functions, and also, in particular, further data which are required for the FMU module or the simulation, e.g., parameter tables, user interface, documentation, etc.

According to an example embodiment of the present invention, the temporal coordination of the simulation of the individual hardware units and of the simulation of the network is carried out by the time simulation unit with the aid of communication points according to the Functional Mock-up Interface. Such communication points in the FMI define, in particular, discrete points in time at which individual modules can, for example, communicate, exchange data, be synchronized with one another.

The present invention represents an extension of the concepts described in German Patent Application Nos. DE 10 2021 212 009.1 and DE 10 2022 200 255.5, the disclosures of which are also included in the content of this application.

German Patent Application No. DE 10 2021 212 009.1 describes a method for simulating a hardware unit in a computing unit, which method allows the simulation of the hardware unit to be carried out as close to reality as possible even with regard to the temporal sequence, and the execution of the software by the hardware unit to be simulated as close to reality as possible in the simulation with regard to the temporal sequence.

German Patent Application No. DE 10 2022 200 255.5 describes a method for processing data associated with a functional simulation of a technical system, which method enables a time simulation to be coupled with the functional simulation, which can increase precision of the simulation. For example, it enables exchange of information regarding an execution duration and/or execution sequence with respect to the functional simulation.

For example, within the scope of the present method, the simulation of the individual hardware units by the hardware simulation unit and the simulation of the network by the network simulation unit can be based on the features described in German Patent Application Nos. DE 10 2021 212 009.1 and DE 10 2022 200 255.5.

A computing unit according to the present invention is configured, in particular with respect to programming, to carry out a method according to the present invention.

Furthermore, the implementation of a method according to the present invention in the form of a computer program or computer program product having program code for carrying out all the method steps is advantageous because it is particularly low-cost, in particular if an executing control unit is also used for further tasks and is therefore present anyway. Finally, a machine-readable storage medium is provided with a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, Intranet, etc.). Such a download can be wired or wireless (e.g. via a WLAN network or a 3G, 4G, 5G or 6G connection, etc.).

Further advantages and embodiments of the present invention can be found in the description and the figures.

The present invention is shown schematically in the figures on the basis of exemplary embodiments and is described below with reference to the figures.

### BRIEF DESCRIPTION OF THE DRAWINGS

FIG. 1 schematically shows a technical device which can be the basis of an example embodiment of the method according to the present invention.

FIG. 2 schematically shows a computing unit which is configured to carry out a preferred embodiment of the method according to the present invention.

### DETAILED DESCRIPTION OF EXAMPLE EMBODIMENTS

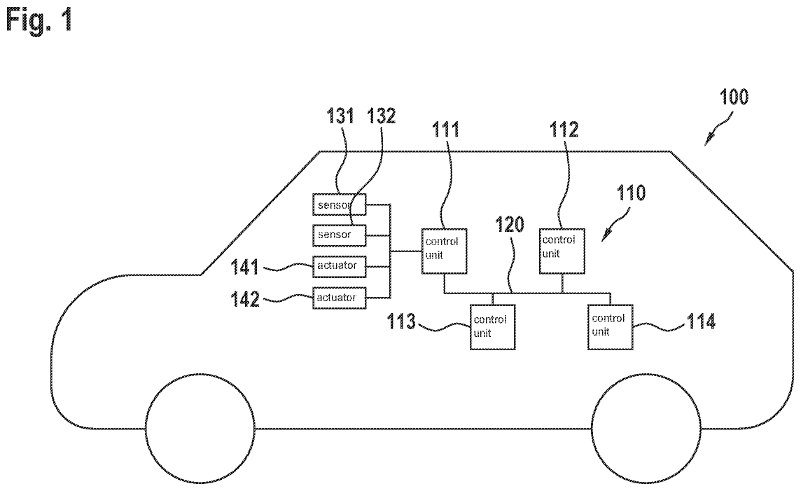

FIG. 1 schematically shows a technical device, which is denoted by 100 and designed, for example, as a (motor) vehicle.

The technical device 100 has a plurality of hardware units 110 which are respectively designed as a control unit 111, 112, 113, 114. For example, these control units 111, 112, 113, 114 can respectively be provided for engine control, for transmission control, for controlling driver assistance functions, infotainment systems, etc. In each of the control units 111, 112, 113, 114, corresponding software is executed for this purpose.

The control units 111, 112, 113, 114 are in data transmission connection with one another via the network 120, for example via a fieldbus, such as CAN, Ethernet/IP, ProfiNet, Sercos 2, Sercos III, EtherCAT, FlexRay, LIN, MOST, etc. The network 120 can be provided, for example, as a global communication system of the vehicle 100.

Individual control units, here, for example, the control unit 111, can furthermore be connected to peripheral devices, such as sensors 131, 132 or actuators 141, 142. For example, the control unit 111 can be connected to these peripheral devices via the network 120 or also via a further network, for example a local communication system. It is understood that a plurality of or even all control units can respectively be connected to corresponding peripheral devices. It is furthermore understood that the vehicle 100 can also have further control units and further components.

In the course of a simulation, the vehicle 100 is to be digitally simulated in a computing unit, for example in order to examine changes in the software of individual control units in a controlled test framework. For example, the complete combination of all control units 111, 112, 113, 114 and the network 120 is to be simulated in the simulation. In this case, the software, which is respectively executed on the individual control units 111, 112, 113, 114, and the communication of the individual control units 111, 112, 113, 114 via the network 120 is to be simulated in a temporally accurate and consistent manner in the simulation.

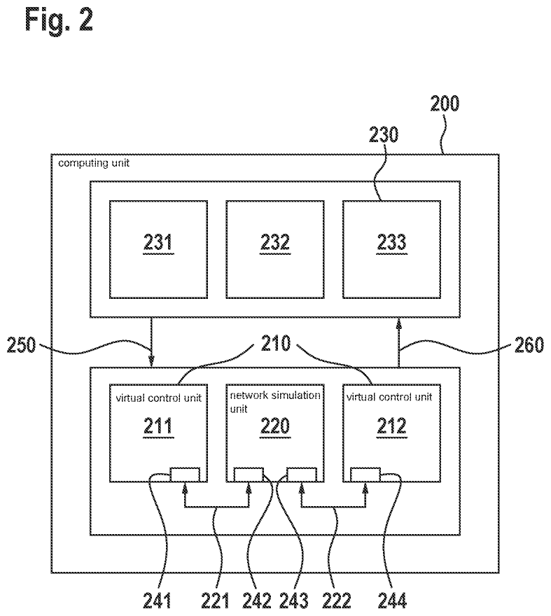

For this purpose, the simulation of the vehicle 100 takes place within the scope of an embodiment of a method according to the present invention, as explained below with reference to FIGS. 1 and 2.

FIG. 2 schematically shows a computing unit 200, which may, for example, be designed as a PC and which is configured, in particular with respect to programming, to carry out an embodiment of the method according to the present invention.

For this purpose, simulation software, which respectively has a hardware simulation unit 210, a network simulation unit 220, and a time simulation unit 230 as a software unit or software block, is executed in the computing unit 200. These hardware-, network-, and time simulation units 210, 220, 230 can respectively be designed, for example, as a software module according to a Functional Mock-up Unit (FMU) and can respectively be connected to one another via an interface according to the Functional Mock-up Interface (FMI).

The hardware simulation unit 210 executes a functional simulation and simulates individual control units 110 of the vehicle 100. For example, two control units 110 of the vehicle 100 are digitally simulated by the hardware simulation unit 210 as a first virtual control unit 211 and a second virtual control unit 212. The software to be executed by the respective actual control unit to be simulated is executed in these virtual control units 211, 212. It is understood that further and in particular all control units of the vehicle can also be simulated by the hardware simulation unit 210. For reasons of clarity, however, only two simulated control units are shown in FIG. 2.

The network simulation unit 220 carries out a network simulation and simulates the network 120 of the vehicle 100. For this purpose, the network simulation unit 220 simulates data transmissions or message transmission between the virtual control units 211, 212. For example, for this purpose, the virtual control units 211, 212 and the network simulation unit 220 can be connected via interfaces 241, 242, 243, 244, which, for example, simulate interfaces according to the UDP (User Datagram Protocol) network protocol. In order to simulate communication between the virtual control units 211, 212, data messages 221 can be exchanged between the virtual control unit 211 and the network simulation unit 220, and data messages 222 can be exchanged between the virtual control unit 212 and the network simulation unit 220.

The simulation of the virtual control units 211, 212 in the hardware simulation unit 210 takes place depending on a process flow plan which describes how processes of the respective software are processed in the corresponding actual control units 110. The process flow plan describes, for example, execution duration, execution sequence, and delay times or latencies of the individual processes of the respective software and also, for example, a real-time behavior of the respective control unit 110.

The simulation of the network 120 is carried out by the network simulation unit 220 depending on a data transmission plan which describes how data transmissions are carried out in the actual network 120. This data transmission plan describes, for example, a transmission duration, transmission sequence, and delay times of individual data transmissions via the network, and also, for example, a real-time behavior of the network 120.

The time simulation unit 230 executes a time simulation, wherein a simulation time base is determined, and wherein the simulated hardware units 211, 212 and the simulated network 220 are temporally coordinated based on the simulation time base. This simulation time base is determined depending on the process flow plan and on the data transmission plan and thus depending on the execution durations, execution sequences, transmission durations, transmission sequences, and delay times stored in these plans.

Depending on the simulation time base, the time simulation unit 230 coordinates individual actions with respect to the execution of the software processes and with respect to the transmission of data messages. For this purpose, the time simulation unit 230 sends time information 250 to the hardware simulation unit 210 and to the network simulation unit 220 in order to instruct these units 210, 220 to carry out specific actions. Furthermore, the hardware simulation unit 210 and the network simulation unit 220 respectively send functionality information 260 to the time simulation unit 230 in order to inform the time simulation unit 230 about actions completely burned out. This time- and functionality information 250, 260 is, for example, sent or received via respective FMI interfaces.

For example, the hardware simulation unit 210 can send corresponding functionality information 260 if a particular process has, for example, been completely processed in the virtual control unit and a result of this process has been determined. If, for example, the processing of this process in the virtual control unit 211 takes place more quickly than would be the case in the corresponding actual control unit, for example due to hardware-dependent execution times or latencies of the actual control unit, the time simulation unit 230 can send corresponding time information 250 to instruct the hardware simulation unit 210 to wait to provide the process result.

For example, the network simulation unit 220 can send corresponding functionality information 260 if a data message 221 has been received from the virtual control unit 211. The time simulation unit 230 can then send corresponding time information 250 to instruct the network simulation unit 220 to transmit a corresponding data message 222 to the virtual control unit 212 at a specific point in time so that a time interval between a transmission time of the message 221 of the virtual control unit 211 and a reception time of the message 221 of the virtual control unit 212 corresponds to a transmission duration in the actual network 120.

The time simulation unit 230 is thus provided as a central clock that is superordinate to the hardware simulation unit 210 and the network simulation unit 220. The time simulation unit 230 represents an integration tool in order to combine physically based models with the correct behavior of E/E networks in the simulation and in order to thus jointly simulate a plurality of virtual control units with the virtual network. The execution of the control unit software and the communication between the control units in the course of the simulation can take place in a temporally coordinated manner with the actual vehicle 100. The vehicle 100 can thus be simulated as realistically as possible.

What is claimed is:

1. A computer-implemented method for simulating a technical device, wherein a plurality of individual hardware units are connected to one another via a network in the technical device to be simulated, the method comprising the following steps:
simulating the individual hardware units by a hardware simulation unit by executing respective software to be executed in the individual hardware units;
simulating the network by a network simulation unit by simulating data transmissions between the individual hardware units via the network;
determining a simulation time base by a time simulation unit; and
temporally coordinating the simulation of the individual hardware units and the simulation of the network, by the time simulation unit, based on the simulation time base.

2. The method as recited in claim 1, wherein the simulation time base is determined depending on a process flow plan, according to which processes of the respective software are respectively processed in the individual hardware units, and/or depending on a data transmission plan according to which data transmissions are carried out in the network.

3. The method as recited in claim 2, wherein: (i) the simulation of the individual hardware units includes determining a process flow plan for each of the individual hardware units and executing the respective software to be executed in the individual hardware units, according to the determined process flow plan, and/or (ii) the simulation of the network includes determining the data transmission plan, and simulating data transmissions between the individual hardware units via the network according to the determined data transmission plan.

4. The method as recited in claim 1, wherein the simulation time base is determined depending on one or more of the following variables:
an execution duration of individual processes of the respective software to be executed in the individual hardware units;
an execution sequence of the individual processes of the respective software to be executed in the individual hardware units;
a delay time of the execution of the individual processes of the respective software to be executed in the individual hardware units;
a transmission duration of individual data transmissions between the individual hardware units via the network;
a transmission sequence of the individual data transmissions between the individual hardware units via the network;
a delay time of the individual data transmissions between the individual hardware units via the network.

5. The method as recited in claim 1, wherein the temporal coordination of the simulation of the individual hardware units and of the simulation of the network based on the simulation time base includes temporally coordinating individual actions with respect to an execution of individual processes of the software to be executed in the individual hardware units, and with respect to a transmission of individual data messages between the individual hardware units via the network (120).

6. The method as recited in claim 1, wherein the temporal coordination of the simulation of the individual hardware units and of the simulation of the network based on the simulation time base includes:
sending time information from the time simulation unit to the hardware simulation unit and to the network simulation unit, including instructions to carry out specific actions;
respectively sending functionality information from the hardware simulation unit and from the network simulation unit to the time simulation unit, including information regarding actions carried out.

7. The method as recited in claim 1, wherein the temporal coordination of the simulation of the individual hardware units and of the simulation of the network based on the simulation time base includes temporally coordinating one or more of the following actions:
reading-in data by the individual hardware units;
writing data by the individual hardware units;
starting an execution of individual processes of the respective software to be executed in the individual hardware units;
ending an execution of individual processes of the respective software to be executed in the individual hardware units;
obtaining process results of individual processes of the respective software to be executed in the individual hardware units;
outputting process results of individual processes of the respective software to be executed in the individual hardware units;
interaction of individual hardware units with the network;
sending individual data messages of individual hardware units via the network;
receiving individual data messages of individual hardware units via the network.

8. The method as recited in claim 1, wherein the time simulation unit is provided as a unit that is superordinate to the hardware simulation unit and the network simulation unit.

9. The method as recited in claim 1, wherein the time simulation unit is respectively connected to the hardware simulation unit and to the network simulation unit via a respective interface according to a Functional Mock-up Interface.

10. The method as recited in claim 1, wherein the time simulation unit and/or the hardware simulation unit and/or the network simulation unit is a software module according to a Functional Mock-up Unit.

11. The method as recited in claim 1, wherein the temporal coordination of the simulation of the individual hardware units and of the simulation of the network is carried out by the time simulation unit using communication points according to the Functional Mock-up Interface.

12. A computing unit configured to simulate a technical device, wherein a plurality of individual hardware units are connected to one another via a network in the technical device to be simulated, the computing device configured to:
simulate the individual hardware units by a hardware simulation unit by executing respective software to be executed in the individual hardware units;
simulate the network by a network simulation unit by simulating data transmissions between the individual hardware units via the network;
determine a simulation time base by a time simulation unit; and
temporally coordinate the simulation of the individual hardware units and the simulation of the network, by the time simulation unit, based on the simulation time base.

13. A non-transitory machine-readable storage medium on which is stored a computer program for simulating a technical device, wherein a plurality of individual hardware units are connected to one another via a network in the technical device to be simulated, the computer program, when executed on a computing unit, causing the computing unit to perform the following steps:
simulating the individual hardware units by a hardware simulation unit by executing respective software to be executed in the individual hardware units;
simulating the network by a network simulation unit by simulating data transmissions between the individual hardware units via the network;
determinating a simulation time base by a time simulation unit; and
temporally coordinating the simulation of the individual hardware units and the simulation of the network, by the time simulation unit, based on the simulation time base.
